(19) United States
(12) Patent Application Publication
(10) Pub. No.: US 2023/0175202 A1
(43) Pub. Date: Jun. 8, 2023

(54) FIBER-REINFORCED COMPOSITE CABLE WITH TOW AND POWER TRANSMISSION LINE

(71) Applicant: TOKYO ROPE MFG.CO., LTD., Tokyo (JP)

(72) Inventors: Akari MATSUDA, Tokyo (JP); Takuji Yamada, Tokyo (JP); Hironobu Yamashita, Tokyo (JP)

(21) Appl. No.: 18/102,222

(22) Filed: Jan. 27, 2023

Related U.S. Application Data
(63) Continuation of application No. PCT/JP21/28742, filed on Aug. 3, 2021.

(30) Foreign Application Priority Data
Aug. 5, 2020 (JP) 2020-132789

(51) Int. Cl. D07B 1/14; H01B 7/00; D07B 1/02

(52) U.S. Cl. CPC D07B 1/147; H01B 7/0009; D07B 1/02; D07B 2201/102; D07B 2201/104; D07B 2201/2067; D07B 2501/2076; D07B 2205/3007; D07B 2205/306; D07B 2205/20; D07B 2201/2066

(57) ABSTRACT

Provided is a cable including a stranded member floating-preventing element that can be easily peeled off.

A power transmission line core includes one core member and six side members twisted around the core member, each member obtained by impregnating a fiber bundle including a plurality of carbon fibers that are continuous in the longitudinal direction and bundled into the fiber bundle with a resin and curing the resin. A tow including a plurality of tow fibers that are continuous in the longitudinal direction and arranged flatly and densely is spirally wound around the surface of the power transmission line core in the direction opposite to the twisting direction of the side members. The tow is detachably entangled in the unevenness on the surface of the power transmission line core.

### CROSS-REFERENCE TO RELATED APPLICATIONS

This application is a Continuation Application of PCT International Application No. PCT/JP2021/028742 filed on Aug. 3, 2021, the entire disclosure of the application being considered part of the disclosure of this application and hereby incorporated by reference.

### BACKGROUND OF THE INVENTION

### Technical Field

The present invention relates to a fiber-reinforced composite cable with a tow and a power transmission line.

### Background Art

An Aluminum Conductor Fiber Reinforced (ACFR), which includes a fiber-reinforced resin (plastic) cable disposed at the center and a plurality of aluminum elements twisted around the fiber-reinforced resin cable, is suitable for use as an overhead power transmission line because of its light weight and high tensile strength. U.S. Pat. No. 9,012,781 B2 discloses an electrical cable in which multiple aluminum elements are twisted around a cylindrical composite core or a stranded composite core.

The stranded composite core is used as the core disposed at the center of the electrical cable, and thus the flexibility of the electrical cable can be enhanced. However, when the stranded composite core is used and aluminum elements are twisted around the core, floating of the side members in the stranded composite core may occur. If the degree of floating of the side members in the stranded composite core is large, the side members may break.

U.S. Pat. No. 9,012,781 B2 describes that an aluminum foil tape in which a glass fabric and a silicon adhesive are stacked is wound around the stranded composite core. Winding the aluminum foil tape around the stranded composite core can prevent floating of the side members in the stranded composite core when the aluminum elements are twisted around the stranded composite core.

For example, in some cases where an end of a power transmission line is locked to a steel tower, the aluminum elements at the end of the power transmission line are cut to expose the composite core and a locking tool is attached to the exposed composite core. An aluminum foil tape wound around the composite core may hinder attachment of the locking tool, and therefore the aluminum foil tape is generally peeled off. However, time and effort are needed for on-site peeling off the aluminum foil tape wound around the composite core with an adhesive.

### DISCLOSURE OF THE INVENTION

An object of the present invention is to provide a cable having a stranded member floating-preventing element that can be easily peeled off.

The fiber-reinforced composite cable with a tow according to the present invention includes: a fiber-reinforced composite cable including a plurality of fiber-reinforced resin (plastic) members that are twisted, each includes a plurality of high-strength fibers that are continuous in a longitudinal direction and bundled into a fiber bundle, each obtained by impregnating the fiber bundle with the resin and curing (hardening) the resin; and a tow including a plurality of fibers that are continuous in a longitudinal direction and arranged flatly and densely, wherein the tow is spirally wound around a surface of the fiber-reinforced composite cable in a direction opposite to a twisting direction of the plurality of fiber-reinforced resin members, and the fibers included in the tow are detachably entangled in the unevenness on the surface of the fiber-reinforced composite cable.

Each fiber-reinforced resin (plastic) member is obtained by impregnating with a resin, a fiber bundle including a plurality of high-strength fibers that are continuous in the longitudinal direction and bundled, and curing the resin.

The high-strength fibers include carbon fibers, glass fibers, boron fibers, aramid fibers, polyethylene fibers, polyparaphenylene benzoxazole (PBO) fibers, basalt fibers, and other fibers. These fibers are very thin, and when a plurality of high-strength fibers are bundled and impregnated with a resin, the resulting product exhibits a high strength. The high-strength fibers may be impregnated with a thermosetting resin or a thermoplastic resin. The resin is cured (hardened) by heating in the case of a thermosetting resin, and by cooling in the case of a thermoplastic resin. Examples of the resin that can be used for impregnation include epoxy, saturated polyester, vinyl ester, phenol, polyamide, and polycarbonate resins.

According to the present invention, the tow including a plurality of fibers that are continuous in the longitudinal direction and arranged flatly and densely is wound around the surface of the fiber-reinforced composite cable, and thus it is possible to prevent floating of the members (stranded members) included in the fiber-reinforced composite cable. Furthermore, the tow is spirally wound in the direction opposite to the spiral direction of the fiber-reinforced composite cable (twisting direction of the members), and thus the tow is prevented from being along the groove on the surface of the fiber-reinforced composite cable and loosening. Moreover, since the tow is not rigidly attached to the surface of the fiber-reinforced composite cable for example by means of an adhesive, the tow can be peeled off by pulling the tow away from the fiber-reinforced composite cable. It is easy to peel off the tow on site.

The tow included in the fiber-reinforced composite cable with a tow according to the present invention is to prevent floating of the members of the fiber-reinforced composite cable, and therefore the tow is to press the members firmly toward the center of the cable. The fibers included in the tow preferably have a strength in a range of 300 to 6,000 MPa. Thus, the tow can sufficiently resist the floating force of the members, without breaking.

If the fibers included in the tow are stretched, the tow becomes incapable of sufficiently resisting the floating force of the members of the fiber-reinforced composite cable. The fibers included in the tow preferably have an elastic modulus (elastic coefficient) in a range of 3,000 to 270,000 MPa. If fibers that are relatively difficult to stretch are used in the tow, the tow can resist the floating force of the members.

In one embodiment, the fibers included in the tow have a melting point or a decomposition point of 150° C. or higher. The fiber-reinforced composite cable with a tow can be used in an environment exposed to a temperature of about 150° C.

As the fibers included in the tow (tow fibers), fibers can be suitably used, specifically, such as polyester, vinylon, nylon, acrylic, and aramid fibers, polyarylate fibers, polyparaphenylene benzoxazole (PBO) fibers, polyphenylene sulfide (PPS) fibers, polyetheretherketone (PEEK) fibers, polyimide fibers, and fluorine fibers.

The tow including a plurality of fibers that are continuous in the longitudinal direction and arranged flatly and densely is used for the purpose of firmly fixing the tow to the surface of the fiber-reinforced composite cable when the tow is wound around the fiber-reinforced composite cable using no adhesive. As described above, each fiber-reinforced resin member included in the fiber-reinforced composite cable is obtained by impregnating a plurality of high-strength fibers with a resin and curing (hardening) the resin, and therefore has fine unevenness on its surface. The fine unevenness remains also in the fiber-reinforced composite cable formed by twisting the fiber-reinforced resin members. The fibers included in the tow are entangled (caught) in the unevenness on the surface of the fiber-reinforced composite cable, and thus the wound tow is firmly fixed to the surface of the fiber-reinforced composite cable. That is, even if no adhesive is used, the tow once wound around the fiber-reinforced composite cable does not slip and loosen. Furthermore, the fiber-reinforced resin member may include a coated filament wound around its outer periphery in the orthogonal direction. If a coated filament is wound around the fiber-reinforced resin member, unevenness on the surface of the fiber-reinforced resin member is formed further remarkably and stably, and the fibers included in the tow are entangled further easily.

No adhesive is used to fix the tow rigidly to the fiber-reinforced composite cable, and therefore, as described above, the tow in a wound state can be firmly fixed to the fiber-reinforced composite cable, and at the same time, the tow is easy to peel off from the fiber-reinforced composite cable. Since no adhesive is required, improvement in yield can also be expected.

In one embodiment, the tow is spirally wound around the surface of the fiber-reinforced composite cable in a manner such that side ends of the tow do not overlap each other. The tow used in a predetermined length of the fiber-reinforced cable with a tow can be shortened to improve the yield. Furthermore, time and effort when the tow is peeled off on site can be reduced.

However, if the interval of winding (pitch of winding) the tow is excessively widened, the effect of suppressing the floating force of the members of the fiber-reinforced composite cable may be not exhibited. In a case where the tow has a predetermined width, the pitch of winding the tow is preferably wider than the width of the tow (thus the side ends of the tow do not overlap each other) and narrower than the pitch of twisting the fiber-reinforced resin members. If the tow is wound around the fiber-reinforced composite cable at a winding pitch narrower than the pitch of twisting the fiber-reinforced resin members, the fiber-reinforced resin members have no portion in which no tow is wound over one pitch.

The fiber-reinforced composite cable preferably includes a core member and a plurality of side members twisted around the core member, and the plurality of side members are each shaped using curability of the resin. The shaping performed in advance using the curability of the resin can ensure an appropriate space or gap inside the fiber-reinforced composite cable, specifically, between the core member and the side members around the core member and between the adjacent side members without impairing the substantially twisted state, and slippage is allowed between the core member and the side members around the core member and between the adjacent side members. A fiber-reinforced composite cable is provided that is easily deflected appropriately when bent and is excellent in handling.

The present invention also provides a power transmission line including the above-described fiber-reinforced composite cable with a tow and a plurality of conductive metal members twisted around the fiber-reinforced composite cable with a tow.

### BRIEF DESCRIPTION OF DRAWINGS

FIG. 1 is a perspective view of a power transmission line.

FIG. 2 is an enlarged sectional view of a carbon fiber-reinforced resin member.

FIG. 3 is an enlarged sectional view of a wrapping tow.

FIG. 4 is an enlarged sectional view of a surface of a carbon fiber-reinforced resin member around which a wrapping tow is wound.

### DETAILED DESCRIPTION OF THE INVENTION

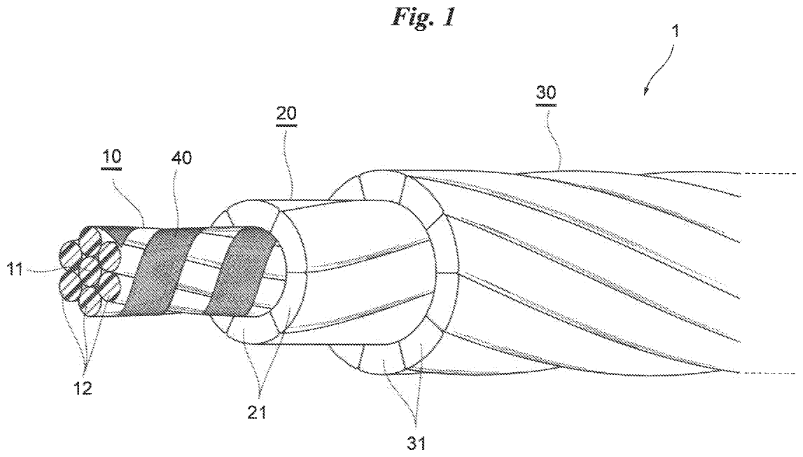

FIG. 1 is a perspective view of a power transmission line 1, and illustrates, in an exposed manner, a power transmission line core 10 positioned at the center of the power transmission line 1 and a conductive layer 20 around the power transmission line core 10.

The power transmission line 1 includes the power transmission line core 10 and conductive layers 20 and 30 surrounding the periphery of the power transmission line core 10. The power transmission line core 10 is used as a reinforcing member of the power transmission line 1, and an electric current flows through the conductive layers 20 and around the power transmission line core 10.

The conductive layers 20 and 30 are formed using a plurality of aluminum elements 21 and a plurality of aluminum elements 31 arranged around the power transmission line core 10, respectively. The power transmission line 1 illustrated in FIG. 1 has a two-layer structure of the conductive layer 20 including six aluminum elements 21 with a trapezoidal cross section and surrounding the power transmission line core 10 and the conductive layer 30 including ten aluminum elements 31 with a trapezoidal cross section and surrounding the conductive layer 20. The aluminum elements 21 and 31 extend in the longitudinal direction of the power transmission line 1 and are gently twisted. An appropriate change is possible in the number of conductive layers surrounding the power transmission line core 10, and in the number and the shape of the aluminum elements 21 and 31 included in the conductive layers 20 and 30 respectively. For example, the aluminum elements 21 and 31 may have a circular cross section.

The power transmission line core 10 includes one long carbon fiber-reinforced resin (plastic) member 11 (hereinafter, also referred to as core member 11) positioned at the center of the power transmission line core 10 and six long carbon fiber-reinforced resin (plastic) members 12 (hereinafter, also referred to as side members 12) twisted around the core member 11, that is, seven carbon fiber-reinforced resin members 11 and 12 in total. The power transmission line core 10 and the carbon fiber-reinforced resin members 11 and 12 each have a substantially circular shape as viewed in the cross section. The power transmission line core 10 is formed to have a diameter of, for example, about 5.0 to 20 mm.

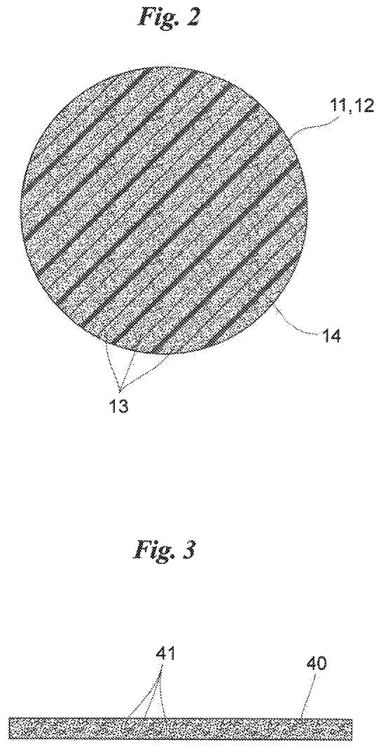

Referring to FIG. 2, FIG. 2 is an enlarged sectional view of the carbon fiber-reinforced resin members 11 and 12 included in the power transmission line core 10. The carbon fiber-reinforced resin members 11 and 12 include a large number of, for example, tens of thousands of long carbon fibers 13 impregnated with a resin 14 and bundled to form a circular cross section, and the entire power transmission line core 10 includes about hundreds of thousands of carbon fibers 13. Each carbon fiber 13 is very thin and has a diameter of, for example, 5.0 to 7.0 μm. The carbon fiber-reinforced resin members 11 and 12 may be formed by twisting a bundle of a large number of carbon fibers 13, or the carbon fiber-reinforced resin members 11 and 12 may be formed by a large number of carbon fibers 13 extending straight. The cross-sectional shapes of the carbon fiber-reinforced resin members 11 and 12 can be appropriately changed, and may be, for example, trapezoidal instead of being circular. Instead of the carbon fiber 13, another high-strength fiber may be used such as a glass fiber, a boron fiber, an aramid fiber, a polyethylene fiber, a PBO fiber, or a basalt fiber. A coated filament, for example, a multifilament of a general-purpose fiber such as a 1000 to 12000 dtex polyester, may be wound around the bundle of the carbon fibers 13 in the orthogonal direction to maintain the cross-sectional circular shape of the bundle of the carbon fibers 13.

The core member 11 and the side members 12 used in the present embodiment have the same thickness (cross-sectional area). A side member 12 may be used that is thinner or thicker than the core member 11. The thickness of each of the core member 11 and the side member 12 can be arbitrarily adjusted by changing the number of carbon fibers 13, and the thickness of the power transmission line core 10 can also be arbitrarily adjusted. As will be understood, the thickness of the power transmission line core 10 can be adjusted by changing the number of side members 12.

The resin 14 may be a thermosetting resin, which is cured (hardened) by heating, or a thermoplastic resin, which is cured (hardened) by cooling. The carbon fiber-reinforced resin members 11 and 12 are produced by impregnating a bundle of carbon fibers 13 with the uncured resin 14 and then heating or cooling the resulting product to cure the resin 14. For example, an epoxy resin, which is a thermosetting resin, can be suitably used as the resin 14 with which the bundle of carbon fibers 13 is impregnated. A resin may be used such as a saturated polyester, vinyl ester, phenol, polyamide, or polycarbonate resin.

In order to allow moderate slippage between the plurality of carbon fiber-reinforced resin members 11 and 12 included in the power transmission line core 10, the side members 12 in a state of being cured using the curability of the resin 14 is to be disposed around the core member 11 in a state of being cured using the curability of the resin 14, and twisted. For example, six side members 12 impregnated with an uncured epoxy resin 14 are twisted around one core member 11 impregnated with the uncured epoxy resin 14 and extending straight, and the entire resulting product is heated to cure the epoxy resin 14. Thereafter, the core member 11 and the six side members 12 are released (the seven carbon fiber-reinforced resin members 11 and 12 are released), and the seven carbon fiber-reinforced resin members 11 and 12 are returned to their original shapes again. Thus, the seven carbon fiber-reinforced resin members 11 and 12 do not constrain each other with the epoxy resin 14, but constrain each other in terms of shape. As described above, moderate slippage is allowed between the plurality of carbon fiber-reinforced resin members 11 and 12, and thus a power transmission line core 10 can be obtained that is strong against bending (less likely to break when bent).

Referring to FIG. 1, the spiral direction of the power transmission line core 10 (twisting direction of the side members 12 included in the power transmission line core 10) and the spiral direction of the conductive layer surrounding the power transmission line core 10 (twisting direction of the aluminum elements 21 included in the conductive layer 20) are opposite to each other. The spiral direction of the conductive layer 20 and the spiral direction of the conductive layer 30 (twisting direction of the aluminum elements 31 included in the conductive layer 30) are also opposite to each other. Unnecessary positional displacement can be prevented between the power transmission line core 10 and the conductive layer 20 and between the conductive layer 20 and the conductive layer 30, and concentration of force on a specific portion (for example, a specific side member 12 among the six side members 12 included in the power transmission line core 10) can be prevented.

Referring to FIG. 1, a wrapping tow 40 is spirally wound around the power transmission line core 10.

The wrapping tow 40 is used for the purpose of preventing floating (jumping out) of the side members 12 included in the power transmission line core 10 to maintain a state in which the six side members 12 are integrated in the power transmission line core 10. As described above, the conductive layers 20 and 30 around the power transmission line core 10 include the plurality of aluminum elements 21 and the plurality of aluminum elements 31 twisted around the power transmission line core 10, respectively. When the aluminum elements 21 and 31 are twisted around the power transmission line core 10, the power transmission line core 10 is pressed from the surroundings toward the center. The aluminum elements 21 and 31 are gradually twisted in one direction from one end to the other end of the power transmission line core 10, and therefore a range already pressed by the aluminum elements 21 and 31 and a range to be pressed coexist to cause a slight difference in the diameter of the power transmission line core 10 between these two ranges. This causes floating of the side members 12 while the aluminum elements 21 and 31 are twisted around the power transmission line core 10. Floating caused in the side members 12 is likely to be accumulated (the degree of floating increases as twisting of the aluminum elements 21 and 31 is promoted), and if floating is accumulated, the side members 12 may break while the aluminum elements 21 and 31 are twisted. If the side member 12 breaks, the power transmission line 1 can no longer be used.

Winding the wrapping tow 40 around the outer peripheral surface of the power transmission line core 10 can prevent or at least reduce floating of the side members 12 that may occur when the aluminum elements 21 and 31 are twisted, and manufacture of the power transmission line 1 can be smoothly completed.

Examples of the fiber that can be used in the wrapping tow 40 include polyester, vinylon, nylon, acrylic, and aramid fibers, polyarylate fibers, PBO fibers, PPS fibers, PEEK fibers, polyimide fibers, and fluorine fibers. These fibers have a strength of 300 to 6,000 MPa and an elastic modulus (elastic coefficient) of 3,000 to 270,000 MPa. The six side members 12 can be firmly bundled by the wrapping tow 40 from their surroundings.

When a current flows through the aluminum elements 21 and 31, the power transmission line 1 may reach a temperature of about 150° C. In the wrapping tow 40, it is also important to use a material that does not melt or decompose thermally under use of the power transmission line 1. That is, a material having a melting point or a decomposition point of 150° C. or higher, preferably 200° C. or higher is suitably used as the material of the wrapping tow 40.

Referring to FIG. 3, FIG. 3 is an enlarged sectional view of the wrapping tow 40. The wrapping tow 40 includes a plurality of tow fibers 41 that are continuous and extend in the longitudinal direction densely. Unlike in the power transmission line core 10, the plurality of tow fibers 41 included in the wrapping tow 40 are not impregnated with a resin or the like, and the plurality of tow fibers 41 do not constrain each other. The wrapping tow 40 is wound around the power transmission line core 10 and thus formed into a tape spreading flat (having an approximately constant width) (see also FIG. 1).

The wrapping tow 40 preferably has a fineness of 1,000 dtex or more. For example, a wrapping tow 40 having a width of about 5.0 mm and a thickness of about 0.1 to 0.2 mm and including aramid fibers having a diameter of several tens of μm has a fineness of about 8,000 dtex.

The wrapping tow 40 is wound around the power transmission line core 10 in the direction opposite to the spiral direction of the power transmission line core 10 (twisting direction of the side members 12). If the wrapping tow 40 is wound in the same direction as the spiral direction of the power transmission line core 10, the wound wrapping tow 40 may loosen in a case where the wrapping tow 40 is along the groove portion between the side members 12. As described above, winding the wrapping tow 40 in the direction opposite to the spiral direction of the power transmission line core 10 can prevent loosening of the wrapping tow 40, and thus the effect of preventing floating of the side members 12 can be sufficiently exhibited.

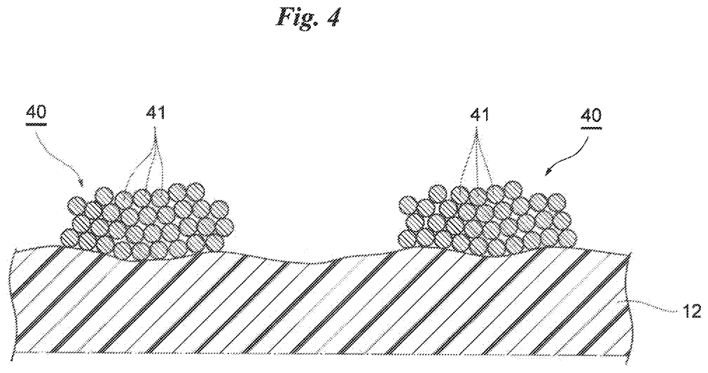

FIG. 4 is an enlarged schematic sectional view of a surface of the power transmission line core 10 (side member 12) around which the wrapping tow 40 is wound. FIG. 4 illustrates two wrapping tows 40. However, it should be understood that not two but one wrapping tow 40 is spirally wound around the power transmission line core 10, and two cross sections of this one wrapping tow 40 are illustrated.

The core member 11 and the side members 12 included in the power transmission line core 10 are obtained by impregnating a bundle of a large number of carbon fibers 13 with an epoxy resin 14 and curing the epoxy resin 14, and therefore have a surface that is not smooth and has fine unevenness. Furthermore, there is also a groove portion between the side members 12. Meanwhile, the wrapping tow wound around the power transmission line core 10 is formed by disposing a large number of thin tow fibers 41 densely. When the wrapping tow 40 is wound around the power transmission line core 10, the large number of tow fibers 41 are detachably entangled (entwined) (slightly caught) in the unevenness (roughness) on the surface of the power transmission line core 10 (side members 12). That is, when the wrapping tow 40 is wound around the power transmission line core 10, the wound wrapping tow 40 does not slip and does not loosen. The wrapping tow 40 only wound around the power transmission line core 10 is firmly fixed to the surface of the power transmission line core 10 (side members 12). If the above-described coated filament is wound around the side members 12, unevenness on the surface of the side members 12 is further remarkably and stably formed, and therefore the wrapping tow 40 is further firmly fixed to the surface of the power transmission line core 10 (side members 12).

The wrapping tow 40 is not in a state of being rigidly fixed to the surface of the power transmission line core 10 using, for example, an adhesive, and therefore the wrapping tow 40 pulled toward the outside of the power transmission line core 10 can be peeled off with a light force. The wrapping tow 40 is easily peeled off also on site.

The wrapping tow 40 may be spirally wound around the power transmission line core 10 tightly without a gap (with the side ends of the wrapping tow 40 overlapping each other). However, even if the wrapping tow 40 is spirally wound around the power transmission line core 10 with a gap, that is, with the side ends of the wrapping tow 40 not overlapping each other, the state is sufficient from the viewpoint of preventing floating of the side members 12. Considering time and effort needed for peeling off the wrapping tow 40 on site, the wrapping tow 40 is preferably wound around the power transmission line core 10 with a gap instead of being tightly wound. As will be understood, an excessively large gap impairs the effect of preventing floating of the side members 12, and therefore the pitch of winding the wrapping tow 40 is to be wider than the width of the wrapping tow 40 and narrower than the pitch of twisting the side members 12.

1. A fiber-reinforced composite cable with a tow, comprising:
a fiber-reinforced composite cable including a plurality of fiber-reinforced resin members that are twisted, the plurality of fiber-reinforced resin members each including a plurality of high-strength fibers that are continuous in a longitudinal direction and bundled into a fiber bundle and a resin, the plurality of fiber-reinforced resin members each obtained by impregnating the fiber bundle with the resin and curing the resin; and
a tow including a plurality of fibers that are continuous in a longitudinal direction and arranged flatly and densely, wherein
the tow is spirally wound around a surface of the fiber-reinforced composite cable in a direction opposite to a twisting direction of the plurality of fiber-reinforced resin members, and
the fibers included in the tow are detachably entangled in the unevenness on the surface of the fiber-reinforced composite cable.

2. The fiber-reinforced composite cable with a tow according to claim 1, wherein
the plurality of fibers included in the tow have a melting point or a decomposition point of 150° C. or higher.

3. The fiber-reinforced composite cable with a tow according to claim 1, wherein
the plurality of fibers included in the tow have a strength in a range of 300 to 6,000 MPa.

4. The fiber-reinforced composite cable with a tow according to claim 1, wherein
the plurality of fibers included in the tow have an elastic modulus in a range of 3,000 to 270,000 MPa.

5. The fiber-reinforced composite cable with a tow according to claim 1, wherein
the tow is spirally wound around the surface of the fiber-reinforced composite cable in a manner such that side ends of the tow do not overlap each other.

6. The fiber-reinforced composite cable with a tow according to claim 1, wherein
the tow has a predetermined width, and a pitch of winding the tow is wider than the predetermined width of the tow and narrower than a pitch of twisting the plurality of fiber-reinforced resin members.

7. The fiber-reinforced composite cable with a tow according to claim 1, wherein
the fiber-reinforced composite cable includes a core member and a plurality of side members twisted around the core member, and the plurality of side members are each shaped using curability of the resin.

8. A power transmission line comprising:
the fiber-reinforced composite cable with a tow according to claim 1; and
a plurality of conductive metal members twisted around the fiber-reinforced composite cable with a tow.
